(19) United States
(12) Patent Application Publication
(10) Pub. No.: US 2017/0112315 A1
(43) Pub. Date: Apr. 27, 2017

(54) HANGERS ATTACHED TO THE GYRO SENSOR AND BEACON AND CLOTHING PRODUCT INFORMATION SYSTEM AND METHOD USING THE SAME

(71) Applicant: SQI Soft, Seoul (KR)

(72) Inventors: Sang Hoon SHIN, Seoul (KR); Jun Ho LIM, Seoul (KR); Gyu Cheol SHIN, Incheon (KR); Seon Gyeon PARK, Seoul (KR); Mi Seok JEONG, Bucheon-si (KR)

(21) Appl. No.: 15/331,066

(22) Filed: Oct. 21, 2016

(30) Foreign Application Priority Data
Oct. 23, 2015 (KR) 10-2015-0147972

(51) Int. Cl. A47G 25/14; H04W 4/00

(52) U.S. Cl. CPC A47G 25/1407; H04W 4/008

(57) ABSTRACT

There is provided a clothes-hanger comprising: a hanger body; and a beacon-signal transmitter attached to the body for transmitting a beacon signal to a wireless device, wherein when the wireless device comes within an effective communication range of the beacon signal from the beacon-signal transmitter, the beacon-signal transmitter transmits the beacon signal including a beacon identity to the wireless device, wherein the beacon identity is associated with the beacon-signal transmitter.

### CROSS-REFERENCE TO RELATED APPLICATION

This application claims the benefit of Korea patent application No. 10-2015-0147972 filed on Oct. 23, 2015, the entire content of which is incorporated herein by reference for all purposes as if fully set forth herein.

### BACKGROUND

Field of the Present Disclosure

The present disclosure relates to clothes information service, and, more particularly, to a smart clothes-hanger for clothes information service and a clothes information service system using the smart hanger.

Discussion of Related Art

A typical clothes-hanger is constituted of a holding part having a grip which is easy to hold clothes and a hook part which is provided at a center of gravity of the holding part.

When using these clothes-hangers in a clothes store, the clothes are hung on a number of clothes-hanger suspended from the clothes hanger rack. In order that the seller or the consumer can find the clothes information, for example, their prices, it is troublesome to ask for the help of the seller or to check the label by manual manipulation of clothes one by one.

In order to solve this problem, a clothes-hanger is used in a clothes shop, which has a clothes information display portion that allows easy identification of clothes information without checking the label of the clothes.

As a conventional technique for this type of clothes-hanger, there is a clothes-hanger with a clothes information display portion as disclosed in Korea Utility Model Registration No. 20-0399457. The hanger of this document is provided with a clothes information display portion protruding from the top of the hook in a plate shape having a predetermined thickness. However, the clothes information display portion has a small indexable area for displaying various kinds of clothes information. Thus, the display of clothing information is limited to simple information such as the size of clothes. Other information should be indicated on the label conventionally. Therefore, consumers' inconvenience to identify various information about clothes still remains.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

The present disclosure is to provide a smart clothes hanger and a clothes information service system using the same, wherein without checking the label attached to the clothes, it is possible to easily receive various information about clothes by using the short distance communication technology and to selectively provide only information about the clothes selected by the consumer when multiple clothes are displayed on the clothes hanger rack suspending the clothes-hangers.

In one aspect of the present disclosure, there is provided a clothes-hanger comprising: a hanger body; and a beacon-signal transmitter attached to the body for transmitting a beacon signal to a wireless device, wherein when the wireless device comes within an effective communication range of the beacon signal from the beacon-signal transmitter, the beacon-signal transmitter transmits the beacon signal including a beacon identity to the wireless device, wherein the beacon identity is associated with the beacon-signal transmitter.

In one implementation, the clothes-hanger may further comprise a gyro sensor attached to the hanger body for measuring an angular velocity of a movement of the hanger body; and a controller attached to the hanger body for receiving the angular velocity from the gyro sensor, for determining whether the angular velocity is equal to or larger than a predetermined activation threshold to activate the beacon-signal transmitter, and for activating the beacon-signal transmitter upon determination that the whether the angular velocity is equal to or larger than the predetermined activation threshold.

In one aspect of the present disclosure, there is provided a clothes information service system comprising: a clothes-hanger comprising a hanger body, a beacon-signal transmitter, a gyro sensor and a controller, wherein the beacon-signal transmitter, the gyro sensor and the controller is attached to the body; a wireless device to communicate with the beacon-signal transmitter; and an information service server to communicate with the wireless device, wherein the beacon-signal transmitter is configured to transmit a beacon signal including a beacon identity to the wireless device, wherein the beacon identity is associated with the beacon-signal transmitter, wherein the gyro sensor is configured to measure an angular velocity of a movement of the hanger body and output the angular velocity to the controller, wherein the controller is configured to receive the angular velocity from the gyro sensor, and determine whether the angular velocity is equal to or larger than a predetermined activation threshold to activate the beacon-signal transmitter, and activate the beacon-signal transmitter upon determination that the whether the angular velocity is equal to or larger than the predetermined activation threshold, wherein the wireless device is configured to determine whether the wireless device comes within an effective communication range of the beacon signal from the beacon-signal transmitter, and to receive from the activated beacon-signal transmitter, the beacon signal including the beacon identity of the activated beacon-signal transmitter, upon determination that the wireless device comes within the effective communication range of the beacon signal from the beacon-signal transmitter, wherein the wireless device is configured to request the information service server of information associated with the beacon identity, wherein upon receipt of the request, the information service server is configured to transmit the information associated with the beacon identity to the wireless device.

In one implementation, the wireless device may be configured to receive only the beacon signal from a closest activated beacon-signal transmitter thereto among multiple activated beacon-signal transmitters.

In one implementation, the wireless device may be configured to receive only the beacon signal having the greatest signal magnitude from multiple beacon signals from the multiple beacon-signal transmitters.

In one aspect of the present disclosure, there is provided a method for providing clothes information, the method comprising: measuring and outputting an angular velocity of a movement of a clothes-hanger body using a gyro sensor attached to the hanger body; determining whether the angular velocity is equal to or large than a predetermined activation threshold to activate a beacon-signal transmitter attached to the hanger body; upon determination that the angular velocity is equal to or large than the predetermined activation threshold, activating the beacon-signal transmitter; determining whether a wireless device comes within an effective communication range of a beacon signal from the beacon-signal transmitter; upon determination that the wireless device comes within the effective communication range of the beacon signal from the beacon-signal transmitter, the wireless device receiving, from the activated beacon-signal transmitter, the beacon signal including a beacon identity associated with the activated beacon-signal transmitter; upon receipt of the beacon identity, the wireless device requesting an information service server of information associated with the beacon identity; and, upon receipt of the request, the information service server transmitting the information associated with the beacon identity to the wireless device.

In one implementation of the method, the wireless device receiving the beacon signal may comprise the wireless receiving only the beacon signal from the closest activated beacon-signal transmitter thereto among multiple activated beacon-signal transmitters.

In one implementation of the method, the wireless device receiving the beacon signal may comprise the wireless device receiving only the beacon signal having the greatest signal magnitude from multiple beacon signals from activated multiple beacon-signal transmitters.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 shows a configuration of a clothes-hanger in accordance with one embodiment of the present disclosure.

FIG. 2 illustrates a system for providing clothes information in accordance with one embodiment of the present disclosure.

FIG. 3 illustrates a flow chart of a method for providing clothes information using the clothes information service system in accordance with the present disclosure.

For simplicity and clarity of illustration, elements in the figures are not necessarily drawn to scale. The same reference numbers in different figures denote the same or similar elements, and as such perform similar functionality. Also, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

### DETAILED DESCRIPTIONS

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

Spatially relative terms, such as “beneath,” “below,” “lower,” “under,” “above,” “upper,” and the like, may be used herein for ease of explanation to describe one element or feature's relationship to another element s or feature s as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented for example, rotated 90 degrees or at other orientations, and the spatially relative descriptors used herein should be interpreted accordingly.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present disclosure refers to “one or more embodiments of the present disclosure.”

The present clothes-hanger may provide a consumer with information about clothes hung on the hanger body, for example, prices, material, manufacturer, etc. for the clothes using a beacon signal.

Classically, beacons were fires lit at well-known locations on hills or high places, used either as lighthouses for navigation at sea, or for signaling over land that enemy troops were approaching, in order to alert defenses. Currently, in wireless networks, a beacon or beacon signal is a type of frame which is sent by the access point (for example, WiFi router) to indicate that the point is on. Bluetooth based beacons periodically send out a data packet. This is typically used by indoor navigation and positioning applications. Generally, the beacon or beacon signal is used for information communication in a short range.

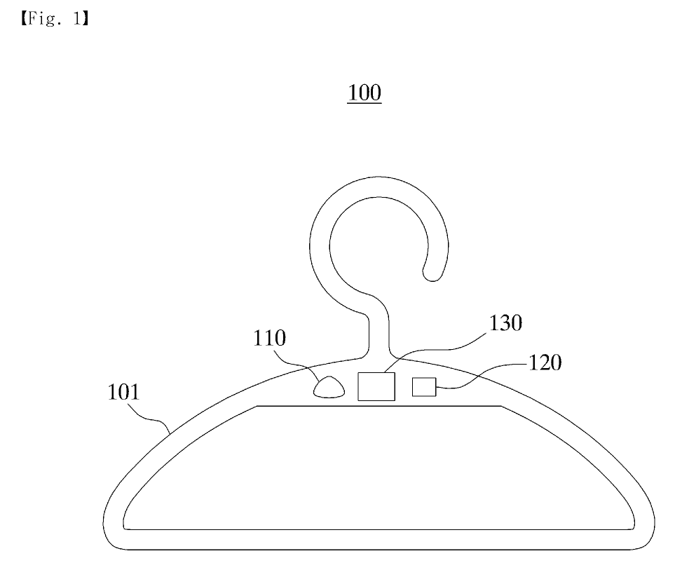

FIG. 1 shows a configuration of a clothes-hanger in accordance with one embodiment of the present disclosure. Referring to FIG. 1, a clothes-hanger 100 in accordance with one embodiment of the present disclosure may include a hanger body 101, and a beacon-signal transmitter 110 attached to the hanger body 101.

The beacon-signal transmitter 110 may be configured to wirelessly transmit a beacon signal to a wireless device. The beacon-signal transmitter 110 may wirelessly transmit a beacon signal using various short-range wireless communication protocols, for example, Wi-Fi, Bluetooth, Zigbee, infrared communication, etc. In one embodiment, the beacon-signal transmitter 110 may wirelessly transmit a beacon signal using a Bluetooth protocol. In this connection, the beacon-signal may have an effective communication range of about 50 meter. Further, the beacon-signal transmitter 110 may have a unique beacon identity. The beacon-signal may include the beacon identity. When the wireless device comes into the effective communication range of the beacon-signal transmitter 110, the beacon-signal transmitter 110 may transmit the beacon signal including the beacon identity thereof to the wireless device. In one example, the beacon signal may include information about clothes hung on the hanger body 101 having the corresponding beacon-signal transmitter 110 attached thereto. In one example, when the wireless device may have an application to allow the device to receive, from a server, information about clothes hung on the hanger body 101 having the corresponding beacon-signal transmitter 110 attached thereto.

There are many hanger bodies 101 to have many clothes hung thereon in the same place. Many hanger bodies 101 may have their own beacon-signal transmitters 110 attached thereto respectively. The beacon-signal transmitters 110 may have their own beacon IDs. Thus, when the beacon-signal transmitters 110 are concurrently transmitting the beacon signals thereof to the wireless device, the wireless device may not be aware of which beacon signal corresponds to the clothes hung on the hanger of interest.

Thus, in order to address the above situation, the beacon-signal transmitter 110 may be selectively activated or deactivated. To this end, the present clothes-hanger may have a gyro sensor 120 and a controller 130 coupled thereto. As used herein, the activation of the beacon-signal transmitter may refer to a power supply to the beacon-signal transmitter via the controller 130 when the beacon-signal transmitter is normally powered off. Alternatively, the activation of the beacon-signal transmitter may refer to an output of the beacon signal from the beacon-signal transmitter via the controller 130 when the beacon-signal transmitter is normally powered on.

The gyro sensor 120 may sense the movement of the hanger body 101. The gyro sensor 120 may be attached to or embedded in the hanger body 101. The gyro sensor 120 may measure an angular velocity of the movement of the hanger body 101. For example, when the body 101 has no movement, the gyro sensor 120 may output the angular velocity as ‘0’. When the hanger body 101 begins to move, the gyro sensor 120 may output the angular velocity as ‘1’. When the hanger body 101 continue to move, the gyro sensor 120 may increase the angular velocity from 1. Thus, when the hanger body 101 is shaken and stop, the angular velocity may change to 1 and the more than 1 and then change to zero. This angular velocity numeric representation may be merely exemplary.

The gyro sensor 120 may measure variations of the angular velocity and may output the variations to the controller 130. Based on the variations, the controller 130 may be configured to activate or deactivate the beacon-signal transmitter 110. To this end, the controller 130 may be connected to the gyro sensor 120 and beacon-signal transmitter 110 in a wired or wireless manner. The gyro sensor 120 may output the variations of the angular velocity of the movement of the hanger body 101 to the controller 130. Then, based on the variations, the controller 130 may activate or deactivate the beacon-signal transmitter 110.

In order to activate the beacon-signal transmitter 110, the controller 130 may have a predetermined activation threshold of the angular velocity of the movement of the hanger body 101. When the angular velocity of the movement of the hanger body 101 is equal or larger than the predetermined activation threshold, the controller 130 may activate the beacon-signal transmitter 110. The predetermined activation threshold may be set to a maximum or nearly maximum of the angular velocity of the movement of the hanger body 101 when the user takes up the hanger body 101. For example, the predetermined activation threshold may be set to a maximum or nearly maximum of the angular velocity of the movement of the hanger body 101 via at least two times vertical shakes or horizontal shakes by the user.

In this way, when the user shakes the clothes-hanger of interest, information about the clothes hung on the shaken hanger body may be displayed on the wireless device. The activation of the beacon-signal transmitter 110 may not be limited to the shake-type movement of the hanger body.

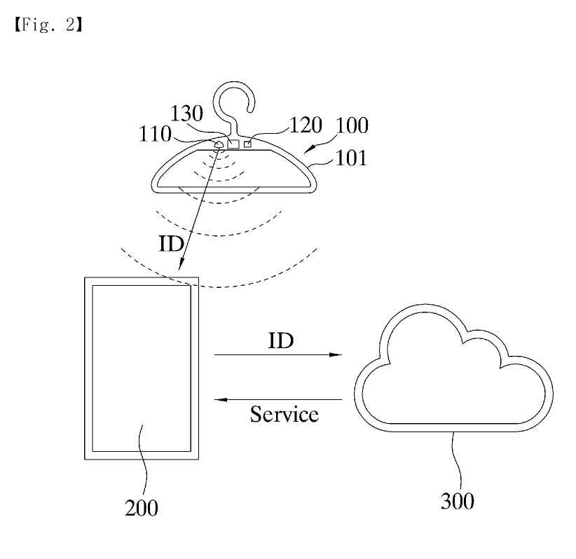

FIG. 2 illustrates a system for providing clothes information in accordance with one embodiment of the present disclosure.

Referring to FIG. 2, a system for providing clothes information in accordance with one embodiment of the present disclosure may include a clothes-hanger 100, a wireless device 200 and an information service server 300.

As described above, the clothes-hanger 100 may include the hanger body 101, the beacon-signal transmitter 110, and gyro sensor 120 and the controller 130, wherein the beacon-signal transmitter 110, and gyro sensor 120 and the controller 130 are attached to or embedded in the body 101.

The wireless device 200 may be configured to communicate with the beacon-signal transmitter 110 attached to the hanger body 101. The wireless device 200 may have a short range wireless communication function. For example, the wireless device 200 may include a smartphone, a tablet PC, a wearable device, etc. Alternatively, the wireless device 200 may be any stationary device having short range wireless communication function and information display function. In one example, the wireless device 200 may be an upright-type wireless device. In one example, the wireless device 200 may be a wall-mounting type wireless device. In one example, the wireless device 200 may be a mirror-type wireless display device.

When the wireless device 200 comes into the effective communication range of the beacon signal from the beacon-signal transmitter 110, the wireless device 200 receives the beacon signal including the beacon identity from the beacon-signal transmitter 110. For example, when the user picks up the clothes hanger 100 and moves toward the wireless device 200 and then comes within the effective communication range of the beacon signal from the beacon-signal transmitter 110, the wireless device 200 receives the beacon signal including the beacon identity from the beacon-signal transmitter 110. Upon receipt of the beacon ID of the beacon-signal transmitter 110, the wireless device 200 may request the information service server 300 of information associated with the beacon identity. Then, the information service server 300 may send the information associated with the beacon identity to the wireless device 200. To do this, the wireless device 200 may have an application installed therein to request the information service server 300 of information associated with the beacon identity and to receive the clothes information from the information service server 300.

The information service server 300 may provide detailed information for the wireless device 200 based on the beacon identity of the beacon-signal transmitter 110. The information service server 300 may be, wirelessly or in a wired manner, connected to the wireless device 200 over a communication network for information service. Using the network, the information service server 300 may supply the information to the wireless device 200 based on the beacon identity. When the wireless device 200 requests the information service server 300 of information associated with the beacon identity, the wireless device 200 may send the beacon identity with the request to the information service server 300. The information service server 300 may have database to store clothes information, more specifically, a relationship between information and beacon identities. Thus, the information service server 300 may identify the beacon identity and fetch information associated with the identified beacon identity from the database based on the relationship, and, then, transmit the fetched information to the wireless device 200.

Hereinafter, a method for providing clothes information using the clothes information service system in accordance with the present disclosure will be described in details.

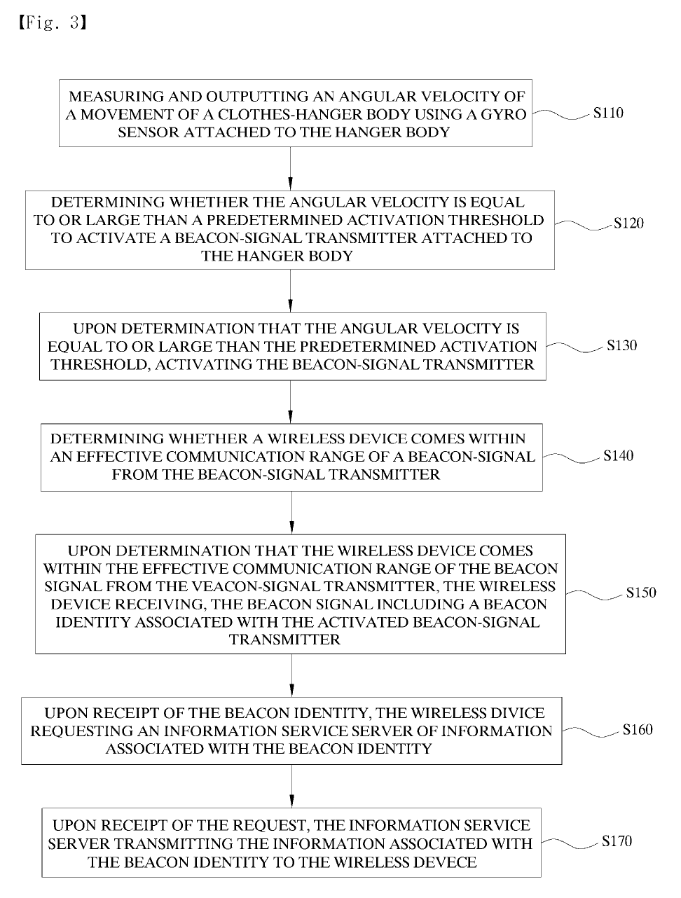

FIG. 3 illustrates a flow chart of a method for providing clothes information using the clothes information service system in accordance with the present disclosure.

Referring to FIG. 3, the method for providing clothes information may include measuring and outputting an angular velocity of a movement of a hanger body using a gyro sensor attached to the hanger body (S110); determining whether the angular velocity is equal to or large than a predetermined activation threshold to activate a beacon-signal transmitter attached to the hanger body (S120); upon determination that the angular velocity is equal to or large than the predetermined activation threshold, activating the beacon-signal transmitter (S130); determining whether a wireless device comes within an effective communication range of a beacon signal from the beacon-signal transmitter (S140); upon determination that the wireless device comes within the effective communication range of the beacon signal from the beacon-signal transmitter, the wireless device receiving, from the activated beacon-signal transmitter, the beacon signal including a beacon identity of the activated beacon-signal transmitter (S150); the wireless device requesting an information service server of information associated with the beacon identity (S160); and, upon receipt of the request, the information service server transmitting the information associated with the beacon identity to the wireless device (S170).

Generally, the clothes is hung on the clothes-hanger which is suspended by the clothes hanger rack to be displayed to the shoppers. The shopper intending to buy the clothes moves toward the mirror while grabbing the clothes-hanger having the clothes hung thereon.

The present clothes information service method may be carried out during the shopper's movement. That is, the shopper intending to buy the clothes moves toward, for example, the stand-type wireless device 200 having a mirror-type display while grabbing the clothes-hanger 100 having the clothes hung thereon. Then, the shopper may shake the clothes-hanger 100 vertically or horizontally. Thus, the method for providing clothes information may be initiated.

When the shopper shakes the clothes-hanger 100 vertically or horizontally, the gyro sensor 120 attached to the hanger body 101 may measure and output an angular velocity of a movement of a hanger body 101 (S110). The measured angular velocity from the gyro sensor 120 may be inputted to the controller 130, which, in turn, determines whether the angular velocity is equal to or large than the predetermined activation threshold to activate a beacon-signal transmitter attached to the hanger body (S120). Then, the shopper may stop shaking the hanger body 101.

Thereafter, upon determination by the controller 130 that the angular velocity is equal to or large than the predetermined activation threshold, the controller 130 may activate the beacon-signal transmitter 110 (S130). Then, the wireless device 200 may determine whether the wireless device 200 comes within an effective communication range of the beacon signal from the beacon-signal transmitter 110 (S140).

For example, as described above, the shopper intending to buy the clothes moves to be adjacent to the stand-type wireless device 200 having a mirror-type display while grabbing the clothes-hanger 100 having the clothes hung thereon. Thus, the wireless device 200 may determine the wireless device 200 comes within the effective communication range of the beacon signal from the beacon-signal transmitter. Then, the wireless device 200 may receive, from the activated beacon-signal transmitter 110, the beacon signal including a beacon identity of the activated beacon-signal transmitter 110 (S150).

Subsequently, upon the receipt of the beacon identity, the wireless device 200 may request the information service server 300 of information associated with the beacon identity (S160). Upon receipt of the request, the information service server 300 may transmit the information associated with the beacon identity to the wireless device 200 (S170).

In this way, information, such as a price, a material for the clothes hung on the clothes-hanger 100 may be displayed on a display unit in the wireless device 200. Thus, the shopper may check the clothes information without help from the clothes shop staff.

In accordance with the present clothes information service system using the present clothes-hanger, the beacon-signal transmitter 110 attached to the hanger body 101 may be deactivated in a normal mode. When the shopper shakes the hanger body 101 in a shaking mode, the beacon-signal transmitter 110 may be activated using the gyro sensor 120 and controller 130 attached to the body 101. In this way, it may be avoided that the single wireless device concurrently receives multiple beacon signals from the multiple beacon-signal transmitters.

For example, the shopper intending to buy the clothes moves toward, for example, the stand-type wireless device 200 having a mirror-type display while grabbing two clothes-hangers 100 having two clothes hung thereon respectively. In this connection, two beacon-signal transmitters 110 attached to the hanger bodies 101 respectively are not activated since the shopper does not shake the clothes-hangers 100 vertically or horizontally. Thus, the wireless device 200 may not communicate with the two beacon-signal transmitters 110. When the shopper shakes one of the two clothes-hangers 100 vertically or horizontally to increase the angular velocity of the gyro sensor 120, thereby to activate only the beacon-signal transmitter 110 attached to the shaken hanger body 101. Thus, the wireless device 200 may selectively communicate with the beacon-signal transmitter 110. Further, the shopper may collect many clothes-hangers 100 into the same place, for example, in a front of the stand-type wireless device 200 and, then, selectively shake hanger bodies 101 one by one. Thus, the information about the multiple clothes may be checked without further movement of the shopper.

Using the present clothes information service system, selective information service may be available. Specifically, among multiple clothes-hangers hanging multiple clothes thereon, the shopper may select one clothes hanger hanging a desired clothes thereon and shake the hanger to activate the beacon-signal transmitter attached thereto, thereby to receive information about the selected clothes.

In the present clothes information service system using the present clothes-hanger, the wireless device 200 may be configured to receive only the beacon signal from the closest clothes-hanger 100 thereto, that is, from the closest beacon-signal transmitter 110 thereto, among the multiple clothes-hangers 100, that is, multiple beacon-signal transmitters 110 which are close to the wireless device 200. In one example, this may be achieved by the wireless device 200 receiving only the beacon signal having the greatest signal magnitude from multiple beacon signals from the multiple beacon-signal transmitters 110.

In this connection, although the wireless device 200 is close to the multiple beacon-signal transmitters 110, the wireless device 200 may selectively communicate with the closest beacon-signal transmitter 110 thereto. Thus, it may be avoided that the wireless device 200 communicates randomly with the beacon-signal transmitters 110 close to the wireless device 200. Thus, it may be avoided that the wireless device 200 receives randomly information about multiple clothes hung on the multiple clothes-hanger 100 close to the wireless device 200.

The above description is not to be taken in a limiting sense, but is made merely for the purpose of describing the general principles of exemplary embodiments, and many additional embodiments of this disclosure are possible. It is understood that no limitation of the scope of the disclosure is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

What is claimed is:

1. A clothes-hanger comprising:
a hanger body; and
a beacon-signal transmitter attached to the body for transmitting a beacon signal to a wireless device,
wherein when the wireless device comes within an effective communication range of the beacon signal from the beacon-signal transmitter, the beacon-signal transmitter transmits the beacon signal including a beacon identity to the wireless device, wherein the beacon identity is associated with the beacon-signal transmitter.

2. The clothes-hanger of claim 1, further comprising:
a gyro sensor attached to the hanger body for measuring an angular velocity of a movement of the hanger body; and
a controller attached to the hanger body for receiving the angular velocity from the gyro sensor, for determining whether the angular velocity is equal to or larger than a predetermined activation threshold to activate the beacon-signal transmitter, and for activating the beacon-signal transmitter upon determination that the whether the angular velocity is equal to or larger than the predetermined activation threshold.

3. A clothes information service system comprising:
a clothes-hanger comprising a hanger body, a beacon-signal transmitter, a gyro sensor and a controller, wherein the beacon-signal transmitter, the gyro sensor and the controller is attached to the body;
a wireless device to communicate with the beacon-signal transmitter; and
an information service server to communicate with the wireless device, wherein the beacon-signal transmitter is configured to transmit a beacon signal including a beacon identity to the wireless device, wherein the beacon identity is associated with the beacon-signal transmitter,
wherein the gyro sensor is configured to measure an angular velocity of a movement of the hanger body and output the angular velocity to the controller,
wherein the controller is configured to receive the angular velocity from the gyro sensor, and determine whether the angular velocity is equal to or larger than a predetermined activation threshold to activate the beacon-signal transmitter, and activate the beacon-signal transmitter upon determination that the whether the angular velocity is equal to or larger than the predetermined activation threshold, wherein the wireless device is configured to determine whether the wireless device comes within an effective communication range of the beacon signal from the beacon-signal transmitter, and to receive from the activated beacon-signal transmitter, the beacon signal including the beacon identity of the activated beacon-signal transmitter, upon determination that the wireless device comes within the effective communication range of the beacon signal from the beacon-signal transmitter,
wherein the wireless device is configured to request the information service server of information associated with the beacon identity, wherein upon receipt of the request, the information service server is configured to transmit the information associated with the beacon identity to the wireless device.

4. The system of claim 3, wherein the wireless device is configured to receive only the beacon signal from a closest activated beacon-signal transmitter thereto among multiple activated beacon-signal transmitters.

5. A method for providing clothes information, the method comprising:
measuring and outputting an angular velocity of a movement of a clothes-hanger body using a gyro sensor attached to the hanger body;
determining whether the angular velocity is equal to or large than a predetermined activation threshold to activate a beacon-signal transmitter attached to the hanger body;
upon determination that the angular velocity is equal to or large than the predetermined activation threshold, activating the beacon-signal transmitter;
determining whether a wireless device comes within an effective communication range of a beacon signal from the beacon-signal transmitter;
upon determination that the wireless device comes within the effective communication range of the beacon signal from the beacon-signal transmitter, the wireless device receiving, from the activated beacon-signal transmitter, the beacon signal including a beacon identity associated with the activated beacon-signal transmitter;
upon receipt of the beacon identity, the wireless device requesting an information service server of information associated with the beacon identity; and,
upon receipt of the request, the information service server transmitting the information associated with the beacon identity to the wireless device.
